(19) United States
(12) Patent Application Publication
(10) Pub. No.: US 2007/0046571 A1
(43) Pub. Date: Mar. 1, 2007

(54) Plasma display panel

(76) Inventors: Seung-Hyun Son, Suwon-si (KR); Sang-Hun Jang, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/508,532

(22) Filed: Aug. 22, 2006

(30) Foreign Application Priority Data
Aug. 24, 2005 (KR) 10-2005-0078049

(51) Int. Cl. G09G 3/28

(52) U.S. Cl. 345/60

(57) ABSTRACT

A plasma display panel (PDP) including an electron emitter disposed between a pair of sustain electrodes to supply electrons is disclosed. The plasma display panel includes: a substrate, a first sustain electrode and a second sustain electrode formed over the substrate and spaced apart from each other, and an electron emitter formed over the substrate and positioned substantially between the first and second sustain electrodes. The electron emitter increases the brightness and luminous efficiency of the PDP by emitting the accelerated electrons into discharge cells.

### CROSS-REFERENCE TO RELATED APPLICATIONS

This application claims the benefit of Korean Patent Application No. 10-2005-0078049, filed on Aug. 24, 2005 in the Korean Intellectual Property Office, the disclosure of which is incorporated herein in its entirety by reference.

### BACKGROUND OF THE INVENTION

1. Field of the Invention

The present invention relates to a plasma display panel (PDP), and more particularly, to a PDP including an electron emitter between sustain electrodes that effectively emits electrons into discharge spaces so as to increase brightness and luminous efficiency of the PDP.

2. Description of the Related Technology

Plasma display panels (PDPs) form images using an electrical discharge, and have a good brightness and viewing angle, etc. PDPs display images using visible light emitted by a process of exciting a phosphor material with ultraviolet rays generated by a discharge of a discharge gas between electrodes when a direct current (DC) voltage or an alternating current (AC) voltage is applied to the electrodes.

PDPs are classified into DC type panels and AC type panels according to their discharge process. In DC type panels, all electrodes are exposed to a discharge space, and thus charges directly move between the electrodes. In AC type panels, at least one electrode is covered by a dielectric layer, and thus the charges do not directly move between the electrodes but wall charges are produced on the dielectric layer. Also, PDPs are classified into opposed discharge type panels and surface discharge type panels according to the arrangement of electrodes. In opposed discharge type panels, a pair of sustain electrodes are disposed in an upper substrate and a bottom substrate, respectively, and thus the discharge is performed in a direction perpendicular to the substrates. In surface discharge type panels, a pair of sustain electrodes are disposed in the same substrate, and thus the discharge is performed in a direction parallel to the substrate.

Opposed discharge type panels have high luminous efficiency, but are easily deteriorated by a plasma discharge. Accordingly, surface discharge type panels have recently become popular. The plasma discharge is also used in flat lamps usually used in backlights of liquid crystal displays (LCDs).

### SUMMARY OF CERTAIN INVENTIVE ASPECTS

One aspect of the invention provides a plasma display panel (PDP). The PDP comprises: a substrate; a first sustain electrode and a second sustain electrode formed over the substrate and spaced apart from each other; and an electron emitter formed over the substrate and positioned substantially between the first and second sustain electrodes.

The PDP may further comprise another substrate opposing the substrate, and a plurality of barrier ribs interposed between the substrates, wherein the plurality of barrier ribs, the substrate, and the other substrate together define a discharge cell, and wherein the electron emitter is configured to supply electrons into the discharge cell. The discharge cell may contain a gas, and the electrons may have sufficient energy to excite the gas, but insufficient to ionize the gas.

The electron emitter may have a surface facing the discharge cell, and the electron emitter may further comprise a protective layer covering at least a portion of the surface. The electron emitter may comprise a first electrode formed over the substrate and an electron acceleration layer formed over the first electrode. The electron acceleration layer may comprise oxidized porous silicon, a boron nitride bamboo shoot, or a metal-insulation-metal (MIM) structure. The first electrode may be configured to be biased to a voltage of about 0V.

The electron emitter may further comprise a second electrode, and the electron acceleration layer may be interposed between the first and second electrodes. The second electrode may be configured to be biased to a voltage higher than the voltage of the first electrode. The first and second electrodes may be together configured to produce an electric field in the discharge cell when the first and second sustain electrodes are activated, and the electron emitter may be configured to emit the electrons when the first and second sustain electrodes are activated. An AC voltage may be applied between the first and second sustain electrodes. A DC voltage may be applied between the first and second sustain electrodes.

One of the sustain electrodes may have a first voltage applied to it and the other sustain electrode may have a second voltage applied to it. The first voltage may be substantially greater than the voltage of the first electrode of the electron emitter, and the second voltage may be less than or equal to the voltage of the first electrode of the electron emitter.

Another aspect of the invention provides a plasma display panel comprising: a first substrate; a second substrate opposing the first substrate; a plurality of barrier ribs interposed between the first and second substrates, wherein the plurality of barrier ribs, the first substrate, and the second substrate together define a plurality of discharge cells; a first sustain electrode and a second sustain electrode formed on an inner surface of the second substrate, the first and second sustain electrode being spaced apart from each other; and an electron emitter positioned in at least one of the plurality of discharge cells so as to be substantially between the first and second sustain electrodes.

The PDP may further comprise a dielectric layer formed substantially across the inner surface of the second substrate, wherein the first and second sustain electrodes are interposed between the second substrate and the dielectric layer, and wherein the electron emitter is exposed to the discharge cell.

The first substrate may comprise a substantially transparent material, and the second substrate may comprise a substantially opaque material. The first substrate may comprise a substantially opaque material, and the second substrate may comprise a substantially transparent material. The PDP may further comprise a phosphor layer formed on an inner surface of the discharge cell, wherein the electron emitter is not covered with the phosphor layer. The phosphor layer comprises a quantum dot.

Another aspect of the invention provides a method of producing visible light with a plasma display panel. The method comprises: providing a plasma display panel comprising: a first substrate; a second substrate; a plurality of barrier ribs interposed between the first and second substrates, wherein the barrier ribs, the first substrate, and the second substrate together define a plurality of discharge cells, each of the discharge cells containing a gas; ionizing the gas so as to produce a plasma within at least one of the discharge cells; and supplying electrons into the at least one of the discharge cells, wherein at least some of the electrons have sufficient energy to excite the gas, but insufficient to ionize the gas.

Another aspect of the invention provides a plasma display panel (PDP) and flat lamps that include an electron emitter that that provides high brightness and luminous efficiency by additionally providing vacuum ultraviolet rays generated by emitting electrons into a discharge space, exciting a discharge gas, and stabilizing the excited discharge gas.

Another aspect of the invention provides a PDP, comprising: a substrate; a plurality of a pair of sustain electrodes disposed on the substrate; an electron emitter disposed between the pair of sustain electrodes to supply electrons.

Another aspect of the invention provides a PDP comprising: a first substrate; a second substrate spaced apart from the first substrate; a plurality of barrier ribs interposed between the first and second substrates to partition the space between the first and second substrates into discharge cells; a pair of sustain electrodes disposed on the second substrate; a pair of address electrodes crossing the pair of sustain electrodes in a discharge cell of the first substrate; a phosphor layer covering at least a portion of the discharge cells; and an electron emitter supplying electrons to the discharge cells.

The electron emitter may include: a first electrode emitting electrons; and an electron acceleration layer accelerating the electrons emitted from the first electrode. The first electrode may be grounded. The electron acceleration layer may be an OPS layer. The electron emitter may further include: a second electrode disposed on the electron acceleration layer to form an electric field between the first electrode and the second electrode. A DC voltage may be applied to the first and second electrodes, and the voltage applied to the second electrode may be greater than the voltage applied to the first electrode. The phosphor layer may include a quantum dot (QD).

### BRIEF DESCRIPTION OF THE DRAWINGS

The above and other features and advantages of the invention will become more apparent by describing in detail exemplary embodiments thereof with reference to the attached drawings in which:

FIG. 1 is an exploded perspective view of a 3 electrode AC drive surface discharge type reflective plasma display panel (PDP);

FIG. 2 is a schematic cross-sectional view of the conventional 3 electrode AC drive surface discharge type reflective PDP illustrated in FIG. 1;

FIG. 3 is a cross-sectional view of an AC 3D reflective PDP including an electron emitter according to an embodiment;

FIG. 4 is a cross-sectional view of a modification of the AC 3D reflective PDP including the electron emitter illustrated in FIG. 3;

FIG. 5 is a cross-sectional view of an AC 3D reflective PDP including an electron emitter according to another embodiment;

FIG. 6 is a cross-sectional view of a modification of the AC 3D reflective PDP including the electron emitter illustrated in FIG. 5;

FIG. 7 is a cross-sectional view of an AC 3D transmissive PDP including an electron emitter according to an embodiment;

FIG. 8 is a cross-sectional view of a modification of the AC 3D transmissive PDP including the electron emitter illustrated in FIG. 7;

FIG. 9 is a cross-sectional view of an AC 3D transmissive PDP including an electron emitter according to another embodiment;

FIG. 10 is a cross-sectional view of a modification of the AC 3D transmissive PDP including the electron emitter illustrated in FIG. 9;

FIG. 11 is a cross-sectional view of a 3D DC reflective PDP including an electron emitter according to an embodiment;

FIG. 12 is a cross-sectional view of a modification of the 3D DC reflective PDP including the electron emitter illustrated in FIG. 11;

FIG. 13 is a cross-sectional view of a 3D DC surface discharge transmissive PDP including an electron emitter according to an embodiment; and

FIG. 14 is a cross-sectional view of a modification of the 3D DC surface discharge transmissive PDP including the electron emitter illustrated in FIG. 13.

### DETAILED DESCRIPTION OF CERTAIN INVENTIVE EMBODIMENTS

Certain inventive embodiments will now be described more fully with reference to the accompanying drawings. In the drawings, like reference numerals indicate identical or functionally similar elements.

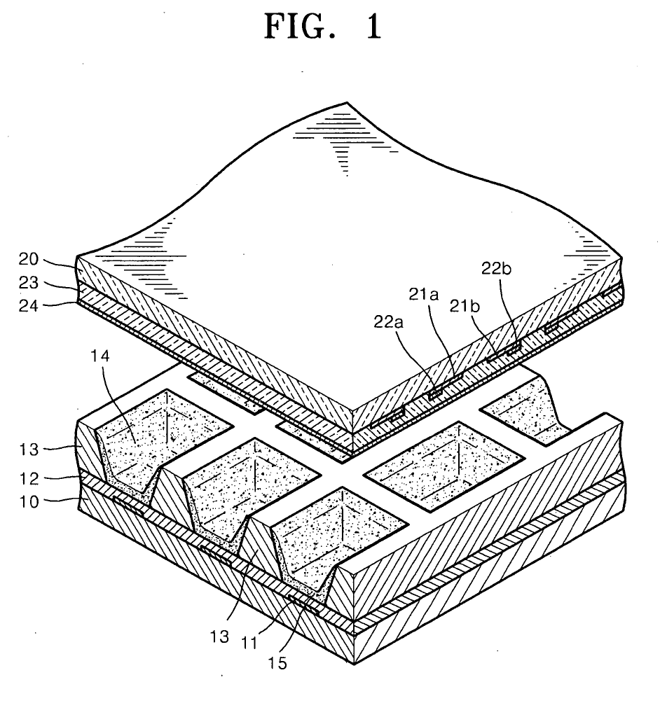

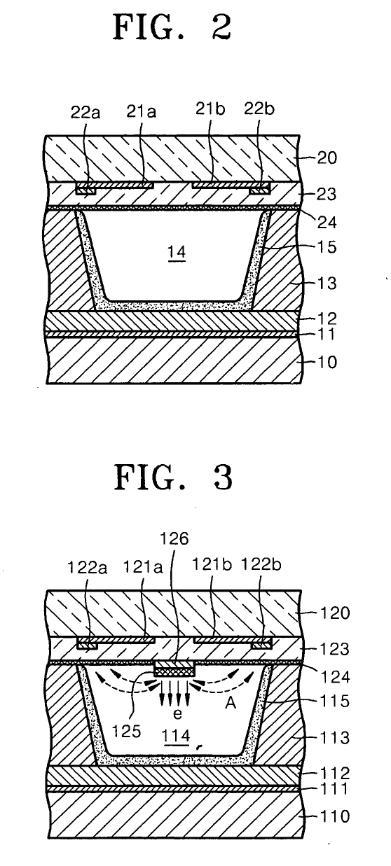

FIG. 1 is an exploded perspective view of a 3 electrode AC drive surface discharge type reflective PDP. FIG. 2 is a schematic cross-sectional view of the 3 electrode AC drive surface discharge type reflective PDP illustrated in FIG. 1. Referring to FIGS. 1 and 2, the 3 electrode AC drive surface discharge type reflective PDP includes a front panel and a rear panel.

The rear panel includes a first substrate 10, a plurality of address electrodes 11, a first dielectric layer 12, barrier ribs 13, and phosphor layers 15. The plurality of address electrodes 11 are spaced apart from one another and disposed parallel to an upper surface of the first substrate 10. The first dielectric layer 12 buries the address electrodes 11. The barrier ribs 13 partition discharge spaces to form discharge cells 14, thereby preventing electrical and optical interference between the discharge cells 14. The phosphor layers 15 cover inner walls of the discharge cells 14, convert ultraviolet rays emitted by an excited discharge gas into red (R), green (G), and blue (B) visible light, and emits the RGB visible light.

The front panel includes a second substrate 20, a plurality of transparent electrodes 21a and 21b, a plurality of bus electrodes 22a and 22b, a second dielectric layer 23, and a protective layer 24. The second substrate 20 is separated from and parallel to the first substrate 10. The plurality of transparent electrodes 21a and 21b are disposed on the bottom surface of the second substrate 20 and cross the plurality of address electrodes 11. The plurality of bus electrodes 21a and 21b are formed of metal, are disposed on the bottom surfaces of the transparent electrodes 21a and 21b, and are parallel to the transparent electrodes 21a and 21b so as to reduce the line resistance of the transparent electrodes 21a and 21b. The second dielectric layer 23 covers the transparent electrodes 21a and 21b and the bus electrodes 22a and 22b. The protective layer 24 covers the dielectric layer 23.

The 3 electrode AC drive surface discharge type reflective PDP and a flat lamp generate ultraviolet rays when the discharge gas, typically xenon (Xe), is excited into excited xenon Xe* and stabilizes through a process of ionization and plasma discharge. Therefore, the 3 electrode AC drive surface discharge type reflective PDP and the flat lamp have a high driving voltage and low luminous efficiency since they require a large amount of energy to ionize the discharge gas.

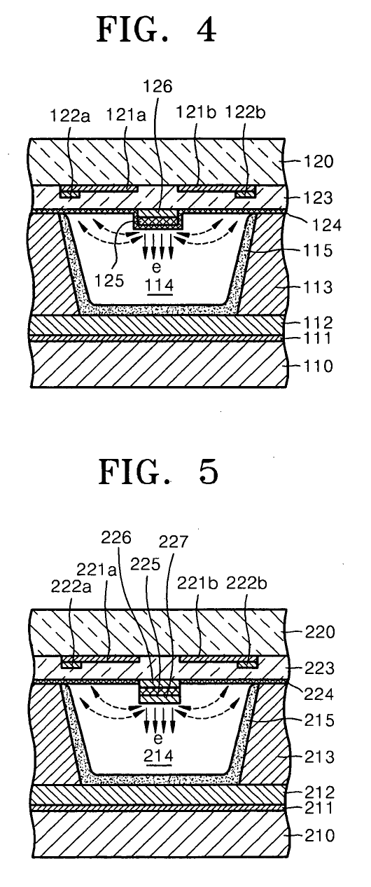

FIG. 3 is a cross-sectional view of an AC 3D reflective plasma display panel (PDP) including an electron emitter according to an embodiment. FIG. 4 is a cross-sectional view of a modification of the AC 3D reflective PDP including the electron emitter illustrated in FIG. 3. Referring to FIG. 3, the AC 3D reflective PDP includes a first substrate 110, a second substrate 120, barrier ribs 113, a pair of sustain electrodes 121a and 122a, and 121b and 122b, a second dielectric layer 123, an address electrode 111, a first dielectric layer 112, a phosphor layer 115, a protective layer 124, and the electron emitter.

The first substrate 110 and the second substrate 120 face each other to form a discharge space therebetween. The second substrate 120 is in the front side where the image is displayed and is formed of a transparent material such as glass to transmit visible light. The barrier ribs 113 partition the discharge space between the first substrate 110 and the second substrate 120 to form discharge cells as a basic unit of an image, and prevent cross talk between discharge cells. In the illustrated embodiment, the barrier ribs 113 have rectangular cross-sections, but the invention is not limited thereto. That is, the cross-sections of the barrier ribs 113 can be oval, circular, or polygonal such as hexagonal, octagonal, etc.

The pair of sustain electrodes 121a and 122a, and 121b and 122b are an X electrode 121a and 122a and a Y electrode 121b and 122b, and are parallel to one another on the inner surface of the second substrate 120. The X electrode 121a and 122a includes a transparent electrode 121a and a bus electrode 122a, and the Y electrode includes a transparent electrode 121b and a bus electrode 122b. The transparent electrodes 121a and 121b are formed of a transparent material such as indium tin oxide (ITO) to transmit visible light. ITO has high electrical resistance, thus causing a voltage drop, and thus may not apply a uniform driving voltage to all the discharge cells. Therefore, in one embodiment, to supplement the low electrical conductivity of the transparent electrodes 121a and 121b, the bus electrodes 122a and 122b that are narrower and have higher electrical conductivity than the transparent electrodes 121a and 121b are disposed on the transparent electrodes 121a and 121b and are electrically connected to the transparent electrodes 121a and 121b. However, the invention is not limited thereto. According to an embodiment, the AC 3D reflective PDP includes transparent electrodes formed of a different material than ITO and may not include bus electrodes.

The first dielectric layer 112 covers and insulates the address electrode 111, and is thus formed of a material having high resistance. The first dielectric layer 112 does not transmit visible light. The second dielectric layer 123 covers and insulates the pair of sustain electrodes 121a and 122a, and 121b and 122b disposed on the second substrate 120, and thus is formed of a material having high resistance and high light transmittance. Some of the charges generated by performing a discharge accumulate around the second dielectric layer 123 and form wall charges due to a voltage applied to the electrodes.

The protective layer 124 covers the second dielectric layer 123 and discharges secondary electrons to facilitate the discharge. The protective layer 124 can be formed of magnesium oxide (MgO). In the embodiment shown in FIG. 4, the protective layer 124 can cover the surface of the electron emitter included in the modified 3D AC reflective PDP.

The phosphor layer 115 covers inner walls of the discharge cells partitioned by the barrier ribs 113. In a photo luminous (PL) mechanism that occurs in the phosphor layer 115, visible light is emitted due to the stabilization of electrons excited by absorbing vacuum ultraviolet rays generated by the discharge. The phosphor layer 115 includes red, green, blue phosphor layers such that the 3D AC reflective PDP can display a color image. A combination of the red, green, and blue phosphor layers constitutes a unit pixel. The phosphor layer 115 can be formed of a material that generates visible light when atoms receive light in an ultraviolet region and are stabilized. For example, the phosphor layer 115 may be a PL phosphor layer or a quantum dot (QD). In particular, since atoms do not interfere with the QD, the QD receives energy from the outside and emits light when electrons in an atom are stabilized. Therefore, the phosphor layer 115 of the AC 3D reflective PDP can be excited with little energy, and thus luminous efficiency can be increased, and the AC 3D reflective PDP can be formed using a print process and be large-sized.

The electron emitter includes a first electrode 126 formed on the bottom surface of the second dielectric layer 123 and an electron acceleration layer 125 that is formed on the bottom surface of the first electrode 126 and has the same width as the first electrode 125. The electron acceleration layer 125 can be formed of a material for accelerating electrons and generating an electron beam, for example, oxidized porous silicon (OPS). The OPS can be oxidized porous poly silicon (OPPS) or oxidized porous amorphous silicon (OPAS). The first electrode 126 can be formed of ITO, Al, or Ag. The first electrode 126 may be connected to a ground, and biased to about 0 V.

In an embodiment, the AC 3D reflective PDP does not include the electron emitter, but the electron acceleration layer 125 includes a boron nitride bamboo shoot (BNBS). The BNBS is transparent to light with a wavelength of about 380-780 nm, which is a visible region, and has good electron emission characteristics since it has a negative electronic affinity. In this case, the first electrode 126 is formed on the surface of the second dielectric layer 123 between the pair of sustain electrodes 121a and 122a, and 121b and 122b. The BNBS layer is formed on the bottom surface of the first electrode 126. The first electrode 126 and the BNBS layer may have the same width.

A discharge gas used in a general PDP can be a gas mixture containing Ne gas, He gas, or a mixture of Ar gas and Xe gas. However, the discharge gas of the invention is not limited thereto. Any mixture of gases can be used as long as it contains a gas that can be excited by external energy generated by an electron beam emitting from the electron emitter and generates UV rays. That is, the discharge gas can be a mixture of gases such as N₂, heavy hydrogen, carbon dioxide, hydrogen gas, carbon monoxide, krypton Kr, etc. and atmospheric air. Therefore, the AC 3D reflective PDP can use a discharge gas used in a typical PDP.

The functions and operation of the AC 3D reflective PDP will now be described. The AC 3D reflective PDP receives an image signal from the outside, converts the image signal into a signal for outputting a desired image through an image processor (not shown) and a logic controller (not shown), and supplies the converted signal to the X electrode 121a and 122a, the Y electrode 121b and 122b, and the address electrode 111. The AC 3D reflective PDP performs an initial reset process, forms wall charges in each of the discharge cells, and alternately applies pulses to the X electrode 121a and 122a and the Y electrode 121b and 122b in a discharge cell selected to output light at a specific time. When the AC 3D reflective PDP applies a driving voltage to the discharge space in the discharge cell through the X electrode 121a and 122a and the Y electrode 121b and 122b, a voltage difference between the X electrode 121a and 122a and the Y electrode 121b and 122b in addition to wall charges formed on the first dielectric layer 112 exceeds a discharge voltage, and thus the discharge occurs between the X electrode 121a and 122a and the Y electrode 121b and 122b.

When the discharge occurs, discharge gas particles in the discharge cell collide, thus generating plasma. Vacuum ultraviolet (VUV) rays emitted due to the stabilization of discharge gas atoms excited in the plasma are absorbed by the phosphor layer 115 that covers side walls of the barrier ribs 113 and the bottom surface of the discharge cell. Thus, electrons are absorbed by the phosphor layer 115 and excited, and when the electrons return to their ground state, they emit visible light. The emitted visible light is combined with visible light generated from other discharge cells, thereby forming an image.

When the discharge occurs, the first electrode 126 is biased to about 0 V. When the discharge occurs between the pair of sustain electrodes 121a and 122a, and 121b and 122b, the discharge space has low electrical resistance such that the OPS layer 125 and the pair of sustain electrodes 121a and 122a, or 121b and 122b have almost the same electric potential. Therefore, a sufficient voltage to accelerate electrons is applied to the OPS layer 125. In this case, the first electrode 126 serves as a cathode electrode, and electrons generated from the cathode electrode are injected into the OPS layer 125. The surface of the nanocrystalline silicon in the OPS layer 125 is covered with a thin film so that most of the applied voltage is applied to the thin oxide film, thereby forming a strong electric field in the OPS layer. The AC 3D reflective PDP alternately applies pulses to the X electrode 121a and 122a and the Y electrode 121b and 122b. The pulses have the same voltage and are applied in an opposite direction so that a voltage sufficient to accelerate electrons can be applied to the OPS layer 125.

Since the oxide film is very thin, the electrons penetrate the oxide film by tunneling effect and are accelerated while the electrons pass through the strong electric field. Such an operation is repeatedly performed in a direction of a surface electrode. Thus, electrons can penetrate through the surface electrode of the OPS layer 125 by the tunneling effect and thus electron beam e can be emitted into the discharge cell. The emitted electron beam e excites the discharge gas and the excited gas generates ultraviolet rays when stabilizing. The ultraviolet rays excite the phosphor layer 115, which in turn generates visible light. The generated visible light is projected toward the second substrate 120, thereby forming an image.

That is, in addition to the vacuum ultraviolet rays generated when the discharge gas atoms are ionized by the plasma discharge, ultraviolet rays are generated when the electron beam e emits from the first electrode 126 through the OPS layer 125 and excites the discharge gas and the excited discharge gas atoms are stabilized. The electron beam e is accelerated through the electron acceleration layer 125, i.e., the OPS layer 125, and is effectively supplied to the discharge cell. Therefore, the AC 3D reflective PDP has high brightness and high luminous efficiency.

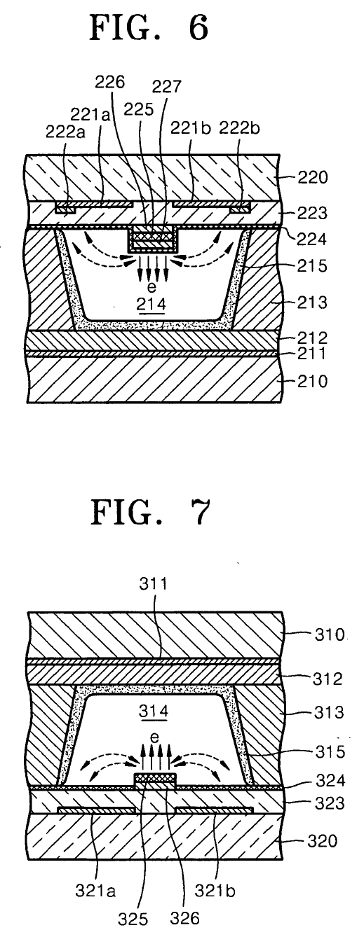

FIG. 5 is a cross-sectional view of an AC 3D reflective PDP including an electron emitter according to another embodiment. FIG. 6 is a cross-sectional view of a modification of the AC 3D reflective PDP including the electron emitter illustrated in FIG. 5. Referring to FIGS. 5 and 6, the AC 3D reflective PDP includes a first substrate 210, a second substrate 220, barrier rib 213, a pair of sustain electrodes 221a and 222a, and 221b and 222b, a first dielectric layer 212, an address electrode 211, a second dielectric layer 223, a phosphor layer 215, a protective layer 224, and the electron emitter.

The electron emitter includes a first electrode 226 formed on the bottom surface of the second dielectric layer 223, an electron acceleration layer 225 that is formed on the bottom surface of the first electrode 226 and has the same width as the first electrode 226, and a second electrode 227 formed on the bottom surface of the electron acceleration layer 225. The second electrode 227 may be formed of a transparent conductive material such as ITO to transmit visible light. Referring to FIG. 6, the protective layer 224, which may be formed of MgO, can cover the surface of the electron emitter. The first electrode 226 serves as a cathode electrode and the second electrode serves as a grid electrode. The first electrode 226 is grounded. A DC voltage is applied between the first electrode 226 and the second electrode 227 so that the acceleration energy of emitted electrons can be controlled according to the magnitude of the DC voltage.

When a predetermined DC voltage is applied between the cathode electrode 226 and the grid electrode 227, the electron acceleration layer 225 accelerates electrons supplied from the cathode electrode and emits an electron beam e into its discharge cell through the grid electrode 227. The electron beam may have energy that is sufficient to excite a gas but insufficient to ionize the gas. In this manner, a magnitude of voltage having the optimized electron energy capable of exciting a discharge gas can be determined.

In another embodiment, the electron acceleration layer 225 can have a metal-insulator-metal (MIM) structure. When a voltage is applied between the cathode electrode and the grid electrode, electrons from the cathode electrode tunnel through a thin insulating layer and are discharged into the discharge space through the grid electrode. The material and thickness of the insulating layer and the grid electrode may be controlled so that the electrons can be discharged into the discharge space with high energy without colliding with the insulating layer.

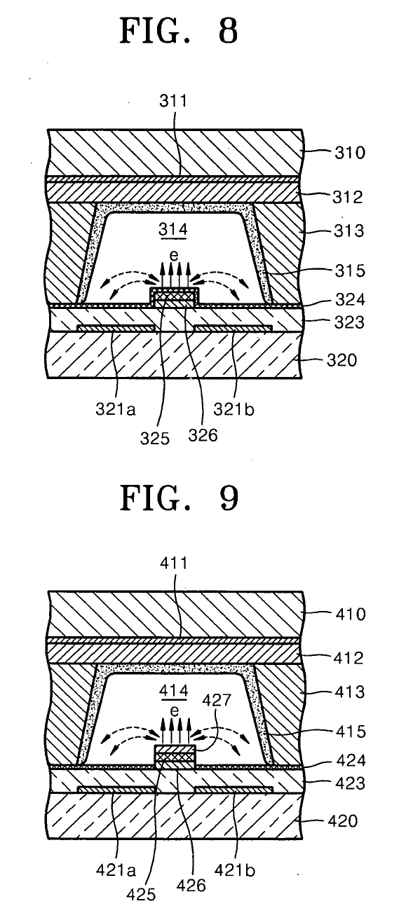

In other embodiments, the structure of the electron emitter between the pair of sustain electrodes can be applied to an AC 3D transmissive PDP. FIG. 7 is a cross-sectional view of an AC 3D transmissive PDP including an electron emitter according to an embodiment. FIG. 8 is a cross-sectional view of a modification of the AC 3D transmissive PDP including the electron emitter illustrated in FIG. 7. The difference between the AC 3D reflective PDP and the AC 3D transmissive PDP will now be described.

Referring to FIGS. 7 and 8, a first substrate 310 is in front side where the image is displayed and is formed of a transparent material such as glass to transmit visible light. An address electrode 311 is formed on the first substrate 310, crosses a pair of sustain electrodes 321a and 321b, and is formed of a transparent conductive material such as ITO to transmit visible light. Although not shown, to compensate for a low electrical conductivity of the ITO, a bus electrode can be formed parallel to the address electrode 311. The bus electrode may be electrically connected by a bridge electrode. A first dielectric layer 312 covers the address electrode 311, and may be formed of a transparent dielectric material to transmit visible light. Since the pair of sustain electrodes 321a and 321b disposed in the second substrate 320 do not need to be transparent, they may be formed of a material having lower electrical resistance than the address electrode 311 formed of ITO. A second dielectric layer 323 may be formed of a white dielectric material to reflect visible light.

The electron emitter includes a first electrode 326 disposed on the upper surface of the second dielectric layer 323, and an electron acceleration layer 325 having the same width as the first electrode 326 and disposed on the upper surface of the first electrode 326. A protective layer 324 can cover the second dielectric layer 323, or, as illustrated in FIG. 8, the protective layer 324 can cover the second dielectric layer 323 and the surface of the electron emitter.

The functions and operation of the AC 3D transmissive PDP according to the embodiment are similar to those of the AC 3D reflective PDP illustrated in FIG. 3. In the PDP of FIG. 7, some of visible light rays emitting from a phosphor layer 315 directly passes through the first substrate 310 while other visible light rays are reflected by a rear panel before passing through the first substrate. The light passing through the first substrate 310 combines with visible light from other discharge cells to form an image.

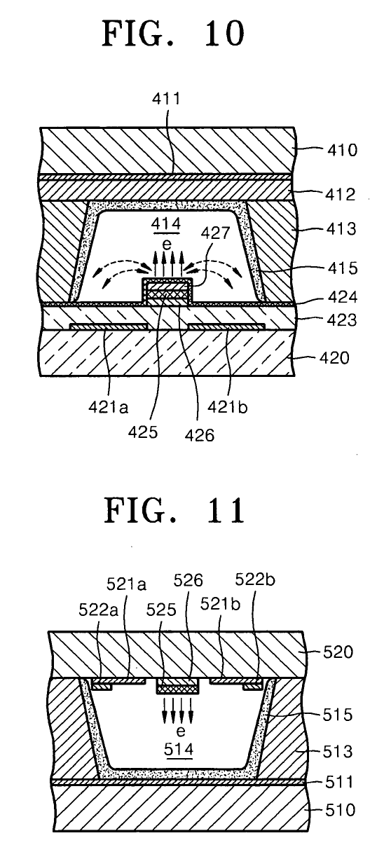

FIG. 9 is a cross-sectional view of an AC 3D transmissive PDP including an electron emitter according to another embodiment. FIG. 10 is a cross-sectional view of a modification of the AC 3D transmissive PDP including the electron emitter illustrated in FIG. 9.

When compared with the electron emitter illustrated in FIGS. 7 and 8, in addition to a first electrode 426 and the electron acceleration layer 425, the electron emitter in FIGS. 9 and 10 further includes a second electrode 427 that has the same width as the electron acceleration layer 425 and is disposed on the upper surface of the electron acceleration layer 425. A protective layer 424 can cover a second dielectric layer 423. As illustrated in FIG. 10, the protective layer 424 can cover the second dielectric layer 323 and the surface of the electron emitter. The first electrode 426 is grounded. In one embodiment, a DC voltage may be applied between the first electrode 426 and the second electrode 427 so that the first and second electrodes 426 and 427 can control the energy of an electron beam e emitting from the electron emitter according to the magnitude of the DC voltage. Therefore, accelerated electrons are effectively supplied to a discharge space through the electron acceleration layer 425 and the first electrode 426 so that the AC 3D transmissive PDP can exhibit high brightness and high luminous efficiency.

The electron emitter according to the current embodiment can apply to a DC surface discharge reflective PDP or a DC 3D transmissive PDP as well as the AC 3D surface discharge reflective PDP or the AC 3D transmissive PDP.

FIG. 11 is a cross-sectional view of a DC surface discharge reflective PDP including an electron emitter according to an embodiment. Referring to FIG. 11, the DC 3D surface discharge reflective PDP includes a first substrate 510, a second substrate 520, a pair of sustain electrodes (X and Y electrodes) 521a and 522a, and 521b and 522b, the electron emitter, an address electrode 511, barrier ribs 513, and a phosphor layer 515. The first substrate 510 and the second substrate 520 face each other to form a discharge space. The pair of sustain electrodes 521a and 522a, and 521b and 522b form stripes parallel to the inner surface of the second substrate 520. The electron emitter is formed on the inner surface of the second substrate 520 between the pair of sustain electrodes 521a and 522a, and 521b and 522b. The address electrode 511 is disposed on the inner surface of the first substrate 510 and cross the pair of sustain electrodes 521a and 522a, and 521b and 522b. The barrier ribs 513 are formed between the first and second substrates and partition discharge spaces. The phosphor layer 515 covers inner walls of a discharge cell.

The electron emitter includes a first electrode 526 disposed on the inner surface of the second substrate 520, and an electron acceleration layer 525 that has the same width as the first electrode 526 and is disposed on the bottom surface of the first electrode 526.

The electron acceleration layer 525 can be formed of a material that can be used to accelerate electrons to generate an electron beam, and may be an OPS layer.

In another embodiment, the electron acceleration layer 525 can have a MIM structure. The OPS layer can be an OPPS layer or an OPAS layer. The first electrode 526 can be formed of ITO, Al, or Ag. The first electrode 526 is connected to a ground, and is biased to about 0V. In another embodiment, the electron acceleration layer 525 can be made of a BNBS.

The functions and operation of the DC 3D reflective PDP will now be described. A DC voltage is applied between the X electrode 521a and 522a and the Y electrode 521b and 522b. If the applied DC voltage exceeds a discharge voltage, a discharge occurs between the X electrode 521a and 522a and the Y electrode 521b and 522b. In one embodiment, a voltage applied to the Y electrode is greater than a voltage applied to the X electrode. A voltage applied to the first electrode 526 may be equal to or greater than a voltage applied to the X electrode 521a and 522a, and may be smaller than a voltage of the Y electrodes 521b and 522b. When the discharge occurs between the pair of sustain electrodes 521a and 522a, and 521b and 522b, a discharge space has low electrical resistance such that the voltage applied to an exposed surface of the OPS layer 526 is almost the same as a voltage applied to the Y electrode. Therefore, a sufficient-voltage to accelerate electrons is applied across the thickness of the OPS layer 526.

As described above, electrons from a cathode electrode may penetrate through the electron acceleration layer 525 by a tunneling effect, and thus an electron beam e can be emitted into the discharge cell. The emitted electron beam e excites the gas, and the excited gas generates ultraviolet rays when stabilized. The ultraviolet rays excite the phosphor layer 515, which in turn generates visible light. The generated visible light is projected to the second substrate 520, thereby forming an image. That is, in addition to the vacuum ultraviolet rays generated when the discharge gas atoms are ionized by the plasma discharge, ultraviolet rays are generated when the electron beam e is emitted through the OPS layer 526 and excites the discharge gas. Therefore, the 3 electrode DC surface discharge reflective PDP can exhibit high brightness and high luminous efficiency.

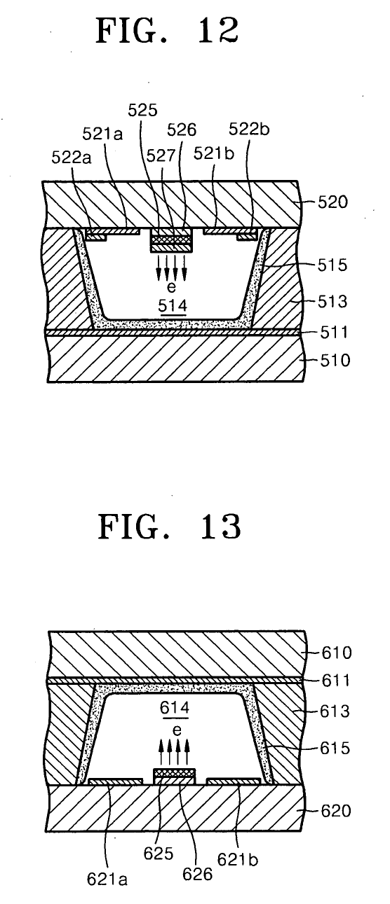

FIG. 12 is a cross-sectional view of a modification of the DC 3D surface discharge reflective PDP including the electron emitter illustrated in FIG. 11. Referring to FIG. 12, the electron emitter includes a first electrode 526 disposed on the inner surface of a second substrate 520, an electron acceleration layer 525 that has the same width as the first electrode 526 and is disposed on the bottom surface of the first electrode 526, and a second electrode 527 disposed on the bottom surface of the electron acceleration layer 525. The first electrode 526 serves as a cathode electrode and the second electrode 527 serves as a grid electrode.

A voltage applied to the first electrode 526 may be greater than or equal to a voltage applied to an X electrode 521a and 522a, and may be less than a voltage applied to the second electrode 527. The voltage applied to the second electrode 527 is less than the voltage applied to the Y electrode 521b and 522b. When a predetermined voltage is applied between the cathode electrode 526 and the grid electrode 527, the electron acceleration layer 525 accelerates electrons supplied from the cathode electrode 526 and emits an electron beam e in a discharge cell through the grid electrode 527. That is, a DC voltage is applied to the first electrode 526 and the second electrode 527 so as to control the energy of the electron beam according to the magnitude of the DC voltage.

The structure of the electron emitter between the pair of sustain electrodes can apply to a DC 3D surface discharge transmissive PDP.

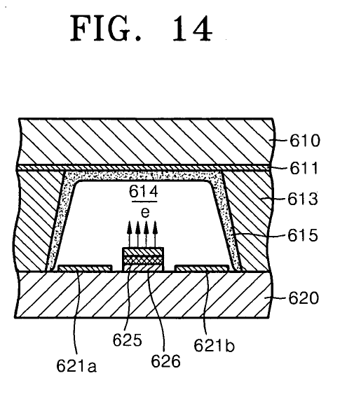

FIG. 13 is a cross-sectional view of a DC 3D surface discharge transmissive PDP including an electron emitter according to an embodiment. FIG. 14 is a cross-sectional view of a modification of the DC 3D surface discharge transmissive PDP including the electron emitter illustrated in FIG. 13. The differences between the DC 3D surface discharge reflective PDP illustrated in FIGS. 11 and 12 and the DC 3D surface discharge transmissive PDP illustrated in FIGS. 13 and 14 will now be described.

Referring to FIGS. 13 and 14, a first substrate 610 is in the front side where the image is displayed and is formed of a transparent material such as glass to transmit visible light emitted from a phosphor layer 615. An address electrode 611 is disposed on a first substrate 610, crosses a pair of sustain electrodes 621a and 621b, and is formed of a transparent conductive material such as ITO to transmit visible light. To supplement the low electrical conductivity of the ITO, a bus electrode (not shown) can be formed parallel to the address electrode 611 via a bridge electrode (not shown). Since the pair of sustain electrodes 621a and 621b disposed on the second substrate 620 do not need to be transparent, they may be formed of a material having lower electrical resistance than the address electrode 611 formed of ITO. The electron emitter includes a first electrode 626 disposed on the upper surface of the second substrates 620, and an electron acceleration layer 625 that has the same width as the first electrode 626 and is disposed in the bottom surface of the first electrode 626. In another embodiment, the electron emitter further includes a second electrode 627 that is disposed over the top surface of the electron acceleration layer 625 and has the same width as the electron acceleration layer 625.

The functions and operation of the DC 3D surface discharge transmissive PDP according to the current embodiment are similar to those of the DC 3D surface discharge reflective PDP illustrated in FIGS. 11 and 12. In the illustrated embodiment, some of visible light rays emitting from the phosphor layer 615 directly pass through the first substrate 610 while other light rays are reflected by a rear panel before passing the first substrate 610. The light passing through the first substrate 610 combines with visible light from other discharge cells to form an image.

The electron emitter between the sustain electrodes can be applied to flat lamps which are used as backlights of LCDs. The flat lamps face each other and include first and second panels forming a discharge space therebetween. A plurality of spacers is interposed between the first and second panels and partition the discharge space into a plurality of discharge cells. The discharge cells are filled with a mixture discharge gas including Ne and Xe. Phosphor layers are formed on inner walls of the discharge cells. In particular, when discharge sustain electrodes are disposed parallel to the surface of one of the first and second panels, i.e., when discharge sustain electrodes of flat lamps in the discharge cell and the electron emitter is disposed between the discharge sustain electrodes, the flat lamps can include discharge cells that exhibit high brightness and high luminous efficiency because of the amplification caused by emitted electrons.

While the invention has been particularly shown and described with reference to exemplary embodiments thereof, it will be understood by those of ordinary skill in the art that various changes in form and details may be made therein without departing from the spirit and scope of the invention as defined by the following claims.

What is claimed is:

1. A plasma display panel (PDP), comprising:
a substrate;
a first sustain electrode and a second sustain electrode formed over the substrate and spaced apart from each other; and
an electron emitter formed over the substrate and positioned substantially between the first and second sustain electrodes.

2. The PDP of claim 1, further comprising another substrate opposing the substrate, and a plurality of barrier ribs interposed between the substrates, wherein the plurality of barrier ribs, the substrate, and the other substrate together define a discharge cell, and wherein the electron emitter is configured to supply electrons into the discharge cell.

3. The PDP of claim 2, wherein the discharge cell contains a gas, and wherein the electrons have sufficient energy to excite the gas, but insufficient to ionize the gas.

4. The PDP of claim 2, wherein the electron emitter has a surface facing the discharge cell, and wherein the electron emitter further comprises a protective layer covering at least a portion of the surface.

5. The PDP of claim 2, wherein the electron emitter comprises a first electrode formed over the substrate and an electron acceleration layer formed over the first electrode.

6. The PDP of claim 5, wherein the electron acceleration layer comprises one selected from the group consisting of oxidized porous silicon, a boron nitride bamboo shoot, and a metal-insulation-metal (MIM) structure.

7. The PDP of claim 5, wherein the first electrode is configured to be biased to a voltage of about 0V.

8. The PDP of claim 7, wherein the electron emitter further comprises a second electrode, and wherein the electron acceleration layer is interposed between the first and second electrodes.

9. The PDP of claim 8, wherein the second electrode is configured to be biased to a voltage higher than the voltage of the first electrode.

10. The PDP of claim 8, wherein the first and second electrodes are together configured to produce an electric field in the discharge cell when the first and second sustain electrodes are activated, and wherein the electron emitter is configured to emit the electrons when the first and second sustain electrodes are activated.

11. The PDP of claim 10, wherein an AC voltage is applied between the first and second sustain electrodes.

12. The PDP of claim 10, wherein a DC voltage is applied between the first and second sustain electrodes.

13. The PDP of claim 12, wherein one of the sustain electrodes has a first voltage applied to it and the other sustain electrode has a second voltage applied to it, and wherein the first voltage is substantially greater than the voltage of the first electrode of the electron emitter, and the second voltage is less than or equal to the voltage of the first electrode of the electron emitter.

14. A plasma display panel comprising:
a first substrate;
a second substrate opposing the first substrate;
a plurality of barrier ribs interposed between the first and second substrates, wherein the plurality of barrier ribs, the first substrate, and the second substrate together define a plurality of discharge cells;
a first sustain electrode and a second sustain electrode formed on an inner surface of the second substrate, the first and second sustain electrode being spaced apart from each other; and
an electron emitter positioned in at least one of the plurality of discharge cells so as to be substantially between the first and second sustain electrodes.

15. The PDP of claim 14, further comprising a dielectric layer formed substantially across the inner surface of the second substrate, wherein the first and second sustain electrodes are interposed between the second substrate and the dielectric layer, and wherein the electron emitter is exposed to the discharge cell.

16. The PDP of claim 15, further comprising a protective layer covering at least the surface of the electron emitter.

17. The PDP of claim 14, wherein the first substrate comprises a substantially transparent material.

18. The PDP of claim 14, wherein the second substrate comprises a substantially transparent material.

19. The PDP of claim 14, further comprising a phosphor layer formed on an inner surface of the discharge cell, wherein the electron emitter is not covered with the phosphor layer.

20. The PDP of claim 19, wherein the phosphor layer comprises a quantum dot.
